(19) United States
(12) Patent Application Publication
(10) Pub. No.: US 2012/0205586 A1
(43) Pub. Date: Aug. 16, 2012

(54) INDIUM PHOSPHIDE COLLOIDAL NANOCRYSTALS

(76) Inventors: Xiaofan Ren, Rochester, NY (US); Keith Brian Kahen, Rochester, NY (US); Matthew Holland, Victor, NY (US)

(21) Appl. No.: 13/024,555

(22) Filed: Feb. 10, 2011

(51) Int. Cl. C09K 11/02; B05D 7/00; B82Y 20/00

(52) U.S. Cl. 252/301.36; 427/215; 977/774

(57) ABSTRACT

A method of making a colloidal solution of indium phosphide semiconductor nanocrystals, includes forming a first solution by combining solvents and ligands; and heating the first solution to a temperature equal to or higher than 290° C. and, while heating, adding to the first solution, a second solution containing trialkylindium, a phosphorus precursor and solvents and ligands so that a reaction takes place that forms a colloidal solution of indium phosphide semiconductor nanocrystals. The method further includes forming core shell indium phosphide semiconductor nanocrystals by forming semiconducting shells on the nanocrystals.

### FIELD OF THE INVENTION

The present invention relates to a colloidal solution of indium phosphide colloidal nanocrystals.

### BACKGROUND OF THE INVENTION

A quantum dot is a semiconductor whose excitons are confined in three spatial dimensions. As a result, it has properties that are between those of bulk semiconductors and those of discrete molecules. An immediate optical feature of colloidal quantum dots is their coloration. Although the material which makes up a quantum dot defines its intrinsic energy signature, quantum dots of the same material, but with different sizes, emit light of different colors. The physical reason is the quantum confinement effect. Quantum confinement results from electrons and holes being squeezed into a dimension that approaches a critical quantum measurement called the exciton Bohr radius. Similar to a molecule, a quantum dot has both a quantized energy spectrum and a quantized density of electronic states.

Colloidal semiconductor quantum dots, or colloidal nanocrystals, have been the focus of a lot of research. They are easier to make in volume than self-assembled quantum dots. Colloidal nanocrystals are synthesized from precursor compounds dissolved in solutions, much like traditional chemical processes. The synthesis is based on a three-component system composed of precursors, organic ligands, and solvents. Nanocrystal growth consists of a nucleation process followed by a growth process. Colloidal nanocrystals can be used in biological applications since they can be dispersed in polar solvents, like water. Additionally, the potential for low cost deposition processes makes colloidal nanocrystals attractive for light emitting devices, such as LEDs, as well as other electronic devices, such as, solar cells, lasers, and quantum computing (cryptography) devices.

For solid-state lighting applications, the fastest route to high efficiency white LEDs is to combine either blue, violet, or near UV LEDs with appropriate phosphors. The prototypical conventional phosphor is Ce³⁺-doped Y₃Al₅O₁₂ (YAG:Ce), a yellow emitter, which in its commercial from Nichia, has a quantum efficiency of 70%. Recently, progress has been made in producing highly efficient green-yellow and red phosphors using nitridosilicates. Despite the very good quantum efficiencies of conventional phosphors, they suffer from enhanced optical backscattering due to their large size, and it is difficult to tune their emission response in order to obtain spectra with specific correlated color temperatures (CCT) having high color rendering index (CR1) values. One alternative to overcome the backscattering loss issue is to form colloidal quantum dot phosphors. As is well known, the quality of colloidal quantum dots can be made to be very high which results in solution quantum yields being 80-90%, and sometimes nearly 100%. In addition to the reduced scattering losses, colloidal quantum dot phosphors also enjoy the advantages of ease of color tuning, improved CR1, a lower cost deposition process, and a broader wavelength spectrum for optical pumping.

The most intensively studied semiconductor nanocrystals are II-VI nanocrystals. As a result of their well-established high-temperature organometallic synthetic methods (Murray et al, J. Am. Chem. Soc. 115, 8706 (1993)), CdSe nanocrystals have been the most extensively investigated among the II-VI nanocrystals. These nanocrystals have size-tunable luminescence emission spanning nearly the entire visible spectrum. In photoluminescent applications, a single light source can be used for simultaneous excitation of different-sized dots. However, II-VI nanocrystals are typically composed of highly toxic elements (Cd or Hg), which restricts their large-scale commercial application. The main advantage offered by III-V nanocrystals, beside their reduced toxicity, lies in the robustness of the covalent bond in III-V semiconductor nanocrystals versus the ionic bond in II-VI semiconductor nanocrystals. The III-V nanocrystals also offer an ideal emission window (700 nm-800 nm) for biomedical applications. Although growth of II-VI semiconductor nanocrystals suggests principals that can be applied to the growth of InP nanocrystals, application of these principles to produce high quality InP nanocrystals has not been straightforward. For example, trioctylphospine oxide (TOPO) is one of the most commonly used ligands for control of the growth of II-VI nanocrystals, with which the growth typically takes less than an hour, and the resulting nanocrystals are highly crystalline and have a narrow size distribution. In contrast, using TOPO as the ligand, a typical synthesis of InP nanocrystals took 3-6 days and the as-prepared nanocrystals did not show any distinguishable absorption peak, indicating a broad size distribution (Peyghambarian et al, J. Phys. Chem. 99, 7754, (1995)). In addition, due to surface traps, dangling bonds, and stacking faults in the crystal and a high activation energy barrier for de-trapping as compared to II-VI nanocrystals, the band edge photoluminescence (PL) quantum yield (QY) of III-V nanocrystals is rather poor (˜1%) (Heath et al, J. Phys. Chem. 100, 7212, (1996)). Strategies to enhance the PL quantum yield include chemically modifying the particle surface or epitaxially growing a shell of a large band gap material around the nanocrystal. InP nanocrystals coated with a ZnCdSe and a ZnS shell (Prasad et al, J. Am. Chem. Soc., 127, 11364 (2005)) as well as InP nanocrystals treated with HF (Talapin et al, J. Phys. Chem. B, 106, 12659 (2002)) showed a significant increase in emission quantum yield.

In 2002, Peng et al. made a large step forward with their usage of non-coordinating or weakly coordinating solvents to produce InP nanocrystals with the characteristics of high crystallinity, monodispersity and solubility (Peng et al, Nano Lett., 9, 1027 (2002)). This new synthetic procedure also greatly shortened the growth time of the InP nanocrystals to less than an hour. They determined the following important experimental conditions: Employ fatty acids with well-defined chain lengths, use non-coordinating or weakly coordinating solvents, use well-defined indium-to-ligand ratios, and employ a thorough degassing process. Though an advancement in the synthetic chemistry of InP nanocrystals at the time, the as-prepared InP nanocrystals still suffered from unsatisfactory PL quantum yields and a limited size range of the nanocrystals (the first exciton absorption peak typically appeared between 500-560 nm).

Recently, many research groups have taken on the task of further development of the synthetic chemistry of InP nanocrystals in non-coordinating or weakly coordinating solvents. To broaden the achievable size range of the InP nanocrystals, Peng's group later adapted a low temperature approach which successfully yielded stable InP nanocrystals that emit from blue to NIR (Peng et al, J. Am. Chem. Soc., 129, 15432 (2007)). However, the emission QY of these nanocrystals (shelled with ZnS) was only in the range of 30-40%. Researchers from Samsung's group reported a stepwise synthesis of InP/ZnS core shell nanocrystals in which the ZnS shell was coated on the InP core by stepwise addition of Zinc acetate and dodecanethiol (Kim et al., Chem. Mater., 21, 573 (2009)). They investigated the roles of zinc and acetic acid on the surface conditions of the InP core and concluded that zinc acetate plays a role in surface etching and ZnS shell formation. Unfortunately, the new shelling technique did not significantly improve the emission QY of the InP nanocrystals and the highest QY they obtained was still below 40%. Two reasons may account for the low QY: (1) the surface or interior of the InP core prepared according to Peng's method (Peng et al, Nano Lett., 9, 1027 (2002)) can have substantial amounts of defects; (2) the large lattice mismatch between InP core and ZnS shell can create further surface defects.

Two research groups have reported InP core shell nanocrystals with emission QY reaching 60%, Nann et al, J. Mater. Chem., 18, 2653 (2008), and 70%, Reiss et al, J. Am. Chem. Soc., 130, 11588 (2008). Both methods incorporate zinc precursors in the initial InP core synthesis, and attributed the high QY of the InP/ZnS nanocrystals partly to role the zinc precursor plays in surface passivation and modification of the InP core. We have made many attempts to reproduce their high quantum efficiency results in our lab, but were unsuccessful.

Trialkylindiums have been widely used as the In precursor to produce InP epitaxial films using metalorganic vapor phase epitaxy (MOVPE). For example, indium phosphide could be grown in a reactor on a substrate by introducing trimethylindium (In(CH₃)₃) and phosphine (PH₃). Nann's group was the first group to report using In(CH₃)₃ to grow colloidal InP nanocrystals (Nann et al, J. Am. Chem. Soc., 128, 1054 (2006)). According to their data, the first exciton absorption peaks of the absorption spectra of the as-prepared crystals are rather broad and indistinguishable (no emission QY data were published), indicating either a relatively low crystallinity of the InP nanocrystals or a broad size distribution. A very recent patent publication (Clough et al.; US 2010/0052512) also reported using In(CH₃)₃ to grow colloidal InP/ZnSe core shell nanocrystals. Except for one experimental example where they reported emission QY of 55-60%, the reported experiments only yielded InP/ZnSe nanocrystals with emission QY in the range of 30-40%. In both cases, the reaction temperatures used to nucleate and grow the nanocrystals were deliberately kept below 280° C. In Nann's report, it was specifically stated that “The best temperature ranges for injection and subsequent crystal growth were found to be 240-280° C. and 180-210° C., respectively”. In Clough's report, it was specifically stated that “In certain embodiments, the reaction is carried out at an injection temperature less than 280° C. Preferably, the reaction injection temperature is in a range from about 175° C. to 260° C., more preferably in a range from 220° C. to 260° C.” Therefore, one reason for the unsatisfying crystal qualities in both cases may be the low reaction temperatures used to initiate the nucleation process and growth of the nanocrystals.

In summary, the synthetic chemistry of InP nanocrystals is challenging. Current limitations of InP nanocrystal materials include low emission efficiency and broad spectral widths. As such, methods for simply and reproducibly producing high quality InP nanocrystals are much desired.

### SUMMARY OF THE INVENTION

In accordance with the present invention, there is provided a method of making a colloidal solution of indium phosphide semiconductor nanocrystals, comprising:

(a) forming a first solution by combining solvents and ligands; and

(b) heating the first solution to a temperature equal to or higher than 290° C. and, while heating, adding to the first solution, a second solution containing trialkylindium, a phosphorus precursor, solvents and ligands so that a reaction takes place that forms a colloidal solution of indium phosphide semiconductor nanocrystals.

### ADVANTAGES

It is an advantage of the present invention to enable a simple and reproducible method of making a colloidal solution of indium phosphide semiconductor nanocrystals.

It is also an advantage of the present invention to enable a method of making core shell colloidal semiconductor nanocrystals including the core comprising indium phosphide made in accordance with the present method, and one or a plurality of semiconducting shells comprising a II-VI or III-V semiconductor disposed on at least a portion of the nanocrystal core surface, wherein the core shell nanocrystals exhibit the desirable properties of high crystallinity, narrow size distribution and an emission quantum yield above 50%.

Another advantage of the present invention is that the indium phosphide nanocrystals exhibiting these properties can be used to create advantaged quantum dot phosphors, medical and biological sensors, high efficiency LEDs and lasers.

### BRIEF DESCRIPTION OF THE DRAWINGS

FIG. 1 shows a schematic of a colloidal semiconductor nanocrystal;

FIG. 2 shows a representation of transmission electron microscopy (TEM) of the InP/ZnSe nanocrystals;

FIG. 3 shows the absorption spectra of the InP/ZnSe nanocrystals made with (a) and without (b) Zn undecylenate; and

FIG. 4 shows the PL spectrum of the InP/ZnSe core shell nanocrystals.

### DETAILED DESCRIPTION OF THE INVENTION

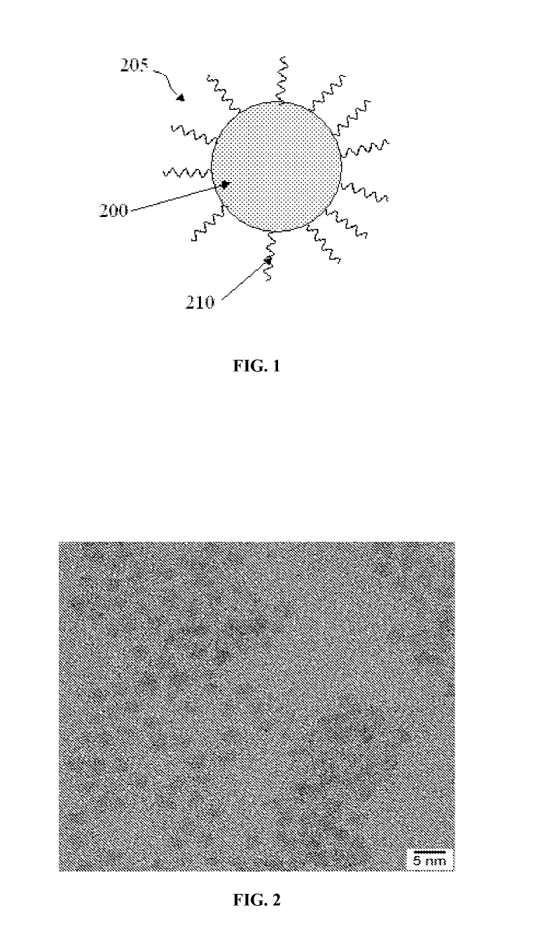

The synthesis of colloidal semiconductor nanocrystals has been an area of immense focus for the past 20 years. Principal interest in semiconductor nanocrystals or quantum dots (QDs) lies in their optical properties which are determined by quantum confinement. The emission efficiencies of semiconductor nanocrystals are generally higher than those of their bulk counterparts and, most importantly, the emission wavelength can be tuned by varying the crystal size. These properties and their resistance to photo-bleaching make semiconductor nanocrystals attractive for many applications, such as phosphors, LEDs, solar cells and biomedical tags. In addition, it is desirable to form devices that not only have good performance, but also are low cost and can be deposited on arbitrary substrates. Using colloidal-based nanocrystals as the building blocks for semiconductor electronic devices would result in devices that confer these advantages as long as the layers are properly engineered. A typical colloidal semiconductor nanocrystal 205 is shown in FIG. 1. In the figure, the nanocrystal 205 is composed of a semiconductor core 200, on whose surface is bonded organic ligands 210. The organic ligands 210 give stability to the resulting colloidal dispersion (the semiconductor nanocrystals 205 and an appropriate solvent). Even though the semiconductor nanocrystal 205 shown in FIG. 1 is spherical in shape, nanocrystals can be synthesized to have shapes ranging from rods and wires, to tetrapods and other multiply-connected nanocrystals. In addition, a shell is often grown outside the semiconductor core with a semiconducting material having an energy bandgap that is higher than that of the core. This bandgap engineering not only moves the exciton-generation zone further away from the surface where quenching can take place, but ensures carrier confinement to the core region.

Synthetic strategies for producing high quality II-VI nanocrystals have been well developed. In brief, II-VI semiconductor nanocrystals are produced by rapidly injecting precursors that undergo pyrolysis in a heated solution containing a solvent and appropriate growth ligands. The precursors rapidly react to form nuclei. Nanostructure growth occurs through monomer addition to the nuclei, typically at a growth temperature lower than the nucleation temperature. During the growth stage, the ligand molecules rapidly adsorb and desorb from the nanocrystal surface, permitting the addition of atoms to the individual nanocrystals while suppressing aggregation of the nanocrystal ensemble. A number of parameters are known to affect the nanocrystal growth and are manipulated, independently or in combination, to control the size and quality of the resulting nanocrystals. These include temperature (nucleation and growth), precursor composition, precursor concentration, ratios of precursors to each other, number of ligands, ligand composition, and ratio of ligands to each other and to the precursors.

III-V nanocrystals are expected to exhibit more enhanced quantum confinement effects as compared to II-VI based nanocrystals since III-V materials generally have higher dielectric constants and smaller effective electron and hole masses. Among the III-V materials, InP is the only one which offers a wide emission color range that covers the visible spectrum. Unfortunately, synthesis of high quality InP nanocrystals is challenging. Existing problems surrounding InP nanocrystals include moderate emission efficiency and poor control of the size distribution.

To overcome these issues, it is useful to look to the results for crystal quality obtained by groups growing InP by molecular beam epitaxy. In that area, people have found that to obtain InP epitiaxial films of the highest quality requires deposition temperatures above 300° C., with the optimum around 400° C. As such, growing high quality InP nanocrystals should occur in this temperature range.

Accordingly, it is an advantage of the invention to overcome the limitations of the prior art and to provide a simple and reproducible method of making a colloidal solution of high quality indium phosphide nanocrystals.

This advantage is solved by a process of producing a colloidal solution of InP nanocrystals, comprising

(a) forming a first solution by combining solvents and ligands; and

(b) heating the first solution to a temperature equal to or higher than 290° C. and, while heating, adding, to the first solution, a second solution containing trialkylindium, a phosphorus precursor, solvents and ligands so that a reaction takes place that forms a colloidal solution of indium phosphide semiconductor nanocrystals.

A wealth of suitable high boiling point compounds exist that can be used as coordinating ligands to stabilize the precursors. They also aid in controlling particle growth and impart colloidal properties to the nanocrystals. In the present invention, examples of advantageous ligands for forming the first solution include carboxylic acids. In some embodiments, the ligand includes CH₃(CH₂)ₙCOOH wherein n=6-18, for example, octanoic [caprylic]acid, nonanic [pelargonic]acid, decanoic [capric]acid, undecanoic acid, dodecanoic [lauric]acid, tridecanoic acid, tetradecanonic [myristic]acid, petadecanoic acid, hexadecanoic [palmitic]acid, heptadecanoic [margaric]acid, octadecanoic [stearic]acid, nonadecanoic acid, eicosanoic [arachidic]acid), or mixtures of any two or more of the foregoing. Other non-limiting examples include 9-octadecenoic [oleic]acid. Other suitable ligands can also be used without limitation. In one embodiment, a ligand for forming the first solution is myristic acid. In some embodiments, the first solution also includes one or more compounds of column II metals, including Zn, Cd or Mg, as the ligands. In some advantageous embodiments, the zinc compound is zinc carboxylate having the formula:

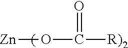

wherein R is a hydrocarbon chain of length equal to or greater than 1 carbon atom and less than 30 carbon atoms, which are saturated, unsaturated, or oligomeric in nature. It can also have aromatic groups in its structure. Specific examples of suitable zinc compounds include but are not limited to zinc acetate, zinc undecylenate, zinc stearate, zinc myristate, zinc laurate, zinc oleate, or zinc palmitate, or combinations thereof.

In some advantageous embodiments, the ligands for forming the first solution include at least a carboxylic acid and a zinc compound. In one embodiment, the ligands for forming the first solution comprise myristic acid and zinc undecylenate.

In addition to carboxylic acid, the ligands forming the first solution can also be selected from amines, phosphines, phosphine oxides, or certain phosphonic acid. Examples of amines include, but are not limited to, primary amines CH₃(CH₂)ₙNH₂ wherein n=5-19 (hexylamine, heptylamine, octylamine, nonylamine, decylamine, undecylamine, dodecylamine, tridecylamine, tetradecylamine, pentadecylamine, hexadecylamine, heptadecylamine, octadecylamine, nonadecylamine, or eciosylamine), and secondary amines (CH₃(CH₂)ₙ)₂NH wherein n=3-11 (dibutylamine, dipentylamine, dihexylamine, diheptylamine, dioctylamine, dinonylamine, didecylamine, diundecylamine, or didodecylamine). Other suitable amines can also be used without a limitation.

In some embodiments, the second solution includes an amine, or combinations of amines, as the ligand. Examples of amines include, but are not limited to, primary amines CH₃(CH₂)ₙNH₂ wherein n=5-19 (hexylamine, heptylamine, octylamine, nonylamine, decylamine, undecylamine, dodecylamine, tridecylamine, tetradecylamine, pentadecylamine, hexadecylamine, heptadecylamine, octadecylamine, nonadecylamine, or eciosylamine), and secondary amines (CH₃(CH₂)ₙ)₂NH wherein n=3-11 (dibutylamine, dipentylamine, dihexylamine, diheptylamine, dioctylamine, dinonylamine, didecylamine, diundecylamine, or didodecylamine). Other suitable amines can also be used without a imitation.

Suitable high boiling point compounds can be used as the reaction media, i.e., the solvents. Examples of non-coordinating or weakly coordinating solvents include, but are not limited to, cis-2-methyl-7-octadecene, squalene, ethers such as 1-tetradecenedioctylether, dodecyl ether, hexadecyl ether, dihexyl ether, butyl phenyl ether and benzyl phenyl ether, esters CH₃(CH₂)ₙC(O)O(CH₂)ₘCH₃ wherein n=4-18 and m=1-8, such as methyl myristate, octyl octanoate, or hexyl octanoate. Examples of non-coordinating solvents include, but are not limited to, squalene, octadecane, or any other saturated hydrocarbon compounds. Mixture of two or more solvents can also be used. In some embodiment, the solvent is selected from unsaturated high boiling point hydrocarbons CH₃(CH₂)ₙCH═CH₂ wherein n=7-30, such as 1-nonadcene, 1-octadecene, 1-heptadecene, 1-pentadecene, or 1-eicosene.

Examples of trialkylindium include, but not limited to, trimethylindium, triethylindium, di-isopropylmethylindium, or ethyldimethylindium, or combinations thereof.

The phosphorus precursor can be selected from hydrogen phosphine, tris(trimethylsilyl)phosphine, tris(dimethylamino)phosphine, tricyclopentylphosphine, tricyclohexylphosphine, triallylphosphine, di-2-norbornylphosphine, dicyclopentylphosphine, dicyclohexylphosphine, dibutylphosphine, cyclohexylphosphine, di-t-butylchlorophosphine, bis(dicyclohexylphosphino)methane, bis(dicyclohexylphosphino)ethane or benzyl-1-adamantylphosphine.

In the present invention, the process of producing the InP nanocrystals is carried out where the second solution is added into the first solution at an injection temperature equal to or higher than 290° C., and more specifically equal to or higher than 300° C. After the addition of the first solution, growth of the InP nanocrystals is carried out at a growth temperature in a range from about 200° C. to 300° C. In some embodiments the growth temperature is in a range from 250° C. to 280° C. It is advantageous that the growth temperature is lower than the injection temperature.

In some embodiments, the InP nanocrystals have a core shell structure. The core shell structure includes an InP core and one shell, the one shell comprising a II-VI compound or a III-V compound. The II-VI or III-V compounds can have either a binary, ternary or quaternary alloy composition. For example, the Ira) core shell nanocrystals is InP/ZnS, InP/ZnSe, InP/ZnSSe, InP/ZnMgSeS, InP/ZnMgSe, InP/ZnMgS, InP/CdSSe, or InP/GalnP. It is well-known that a large lattice mismatch between core and shell materials leads to an accumulation of interfacial strain. Such strain eventually can be released through the formation of misfit dislocations that degrade optical properties. Therefore, it is advantageous that the shell material is chosen such that the difference between the crystal lattice values of the shell and the core materials is reduced.

In some embodiments, the InP core shell nanocrystals comprise an InP core and a plurality of shells. In one embodiment, for example, nanocrystals comprise a core shell shell structure having an InP core, a first shell and a second shell, where each shell includes a II-VI or III-V compound, having a binary, ternary or quaternary alloy composition. In some embodiments, the compositions of the individual shells are chosen independently of one another. Examples of a core shell shell structure having an InP core include, but are not limited to, InP/ZnSe/ZnS, InP/GalnP/ZnSe, InP/GalnP/ZnS, InP/ZnCdSe/ZnMgSeS or InP/ZnCdSe/MgS. In some embodiments, InP nanocrystals comprise a core shell shell shell structure including but not limited to InP/GaInP/ZnSe/ZnS or InP/ZnCdSe/ZnSe/ZnS.

For proper confinement it is preferred that the bandgap of the shell material is larger than the bandgap of the InP core. In some embodiments, the bandgap of the outer shell material is larger than the bandgap of the InP core and any other intervening shell material(s). In one embodiment, a core shell shell nanocrystal includes an InP core, a first shell and a second shell, wherein the first shell has a larger bandgap than the core and the second shell has a larger band gap than the first shell.

In some embodiments, the shelling of the InP nanocrystals includes adding the cation precursor(s) and anion precursor(s) of the shell material to a colloidal solution of InP nanocrystals simultaneously. In some embodiments, the InP nanocrystals are contacted first with the cation precursor solution to provide InP nanocrystal with a monolayer of cations. In other embodiments, the InP nanocrystals are contacted first with the anion precursor solution to provide the nanocrystals with a monolayer of anions. In some embodiments, one or a plurality of shells are formed on InP core nanocrystals according to successive ion layer absorption and reaction (SILAR) techniques.

In some embodiments, when adding cation precursor(s) and anion precursor(s) in an alternative manner to the reaction vessel comprising InP nanocrystals, the MP nanocrystals are not washed or otherwise purified between the alternating additions of cation and anion precursor solutions.

In one embodiment, a process of producing a colloidal solution of InP nanocrystals shelled with a binary, ternary, or quaternary II-VI or III-V semiconductor material includes:

(a) forming a first solution by combining solvents and ligands;

(b) heating the first solution to a temperature equal to or higher than 290° C. and, while heating, adding, to the first solution, a second solution containing trimethyl indium, a phosphorous precursor, solvents and ligands so that a reaction takes place that forms a colloidal solution of indium phosphide semiconductor nanocrystals; and

(c) adding one or more than one column II or III precursors to the colloidal solution of indium phosphide core semiconductor nanocrystals; annealing the combined solution; then to the annealed solution, adding one or more than one column VI or V precursors to form a colloidal solution of core shell indium phosphide nanocrystals.

An advantageous temperature range for the annealing step in (c) is between 150° C. to 280° C., and more specifically between 180° C. to 250° C. The column II precursor used for shelling the InP nanocrystals is a column II material selected from Cd, Zn, or Mg. In some embodiments, the column II precursor is a chemical compound selected from Cd(Me)₂, CdO, CdCO₃, Cd(Ac)₂, CdCl₂, Cd(NO₃)₂, CdSO₄, ZnO, ZnCO₃, Zn(Ac)₂, Zn(Et)₂, Mg(acac)₂, MgCl₂, Mg stearate, Bis(cyclopentadienyl) magnesium or Mg(Ac)₂, or any compound including the column II metals, such as, Cd, Zn, or Mg, or combinations thereof. In one embodiment, the column II precursor is Zn(Ac)₂. In another embodiment, the column II precursor is Zn(Et)₂. Other appropriate cation precursors can also be used without limitation.

The column VI precursor used for shelling the InP nanocrystals is a material selected from S, Se, or Te. In some embodiments, the column VI precursor is a material selected from sulfur, bis(trimethylsilyl)sulfide, tri-n-alkylphosphine sulfide, hydrogen sulfide, tri-n-alkenylphosphine sulfide, alkylamino sulfide, alkenylamino sulfide, tri-n-butylphosphine sulfide, tri-n-octylphosphine sulfide, tri-n-alkylphosphine selenide, alkenylaminoe selenide, tri-n-alkylamino selenide, tri-n-alkenylphosphine selenide, tri-n-butylphosphine selenide, tri-n-octylphosphine selenide, selenourea, tri-n-alkylphosphine telluride, alkenylaminoe telluride, tri-n-alkylamino telluride, tri-n-alkenylphosphine telluride, tri-n-butylphosphine telluride, or tri-n-octylphosphine telluride, or combinations thereof. Other appropriate anion precursors can also be used without limitation.

The column III precursor used for shelling the InP nanocrystals is a column III material selected from Al, Ga, or In. In some embodiments, the column III precursor is a chemical compound selected from Al(Me)₃, Al(Ac)₃, Al(acac)₃, AlCl₃, Ga(Me)₃, Ga(Et)₃, Ga(acac)₃, GaCl₃, In(Ac)₃, InCl₃, In(Me)₃, In(Et)₃, or InC₅H₅. Other appropriate cation precursors can also be used without limitation. The column V precursor used for shelling the InP nanocrystals is a column V material selected from N, P, or As. In some embodiments, the P precursor is a chemical compound selected from hydrogen phosphine, tris(trimethylsilyl)phosphine, tris(dimethylamino)phosphine, tricyclopentylphosphine, tricyclohexylphosphine, triallylphosphine, di-2-norbornylphosphine, dicyclopentylphosphine, dicyclohexylphosphine, dibutylphosphine, cyclohexylphosphine, di-t-butylchlorophosphine, bis(dicyclohexylphosphino)methane, bis(dicyclohexylphosphino)ethane or benzyl-1-adamantylphosphine. In some embodiments, the As precursor is selected from tris(trimethylsilyl)arsine, tris(dimethylamino)arsine, tricyclopentylarsine, tricyclohexylarsine, or triallylarsine In some embodiments, the N precursor is selected from tert-butylamine. Other appropriate anion precursors can also be used without limitation.

Colloidal semiconductor nanocrystals have been the subject of intensive experimental and theoretical study because of their emission phenomena associated with 3D quantum confinement. The InP nanocrystals disclosed in the present invention emit strongly in the visible region, with a photoluminescence (PL) quantum yield of no less than 40%, and in most cases, no less than 50%. In some embodiments, the light emission quantum yield of the as-prepared InP nanocrystals is no less than 60%. In some embodiments, the luminescence includes a maximum peak emission with a full width at half maximum (FWHM) of not more than 70 nm, not more than 60 nm, or not more than 50 nm.

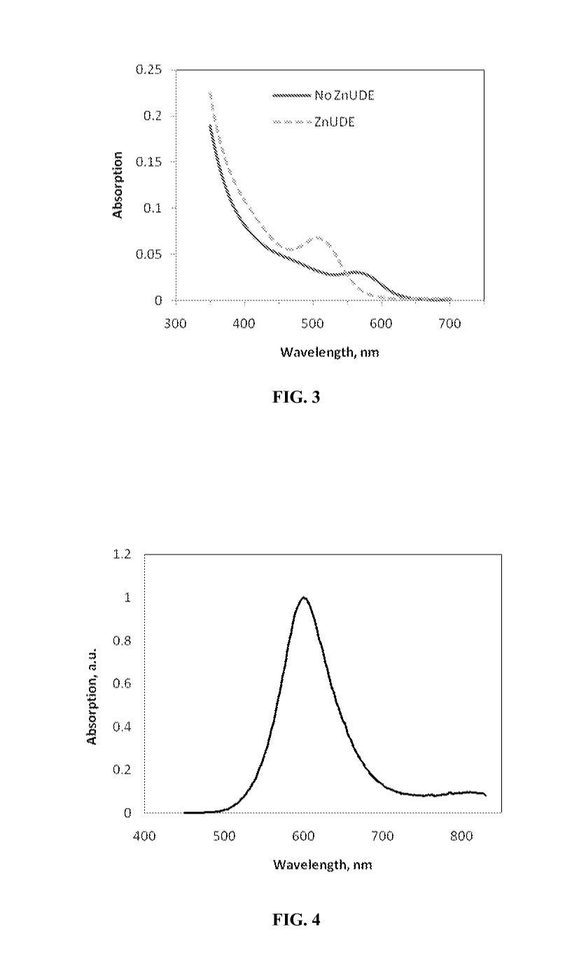

In the embodiment illustrated by FIG. 2, a representation of the Transmission Electron Microscopy (TEM) of the InP/ZnSe nanocrystals is shown. In the embodiments illustrated by FIG. 3 and FIG. 4, the as-prepared nanocrystals comprised a core shell structure having an InP core followed by a ZnSe shell. FIG. 3 shows the absorption spectra of InP/ZnSe nanocrystals made with (a) and without (b) ZnUDE (Zn UDE: zinc undecylenate) being added during the formation of the InP core. As shown in FIG. 3, the addition of the ligand ZnUDE resulted in a significant blue shift of the first exciton peak which is also much more distinguishable. FIG. 4 shows the PL spectrum of the as prepared InP/ZnSe core shell nanocrystals. The as prepared core shell nanocrystals demonstrated a PL quantum yield of 63% with a FWHM of 60 nm. Details of the synthetic procedure associated with these core shell nanocrystals are given in Example 2 below.

In some embodiments, the semiconductor nanocrystals are dispersed in a matrix. In some embodiments, the semiconductor nanocrystals are randomly dispersed in the matrix. In other embodiments, the semiconductor nanocrystals are homogeneously dispersed in the matrix. Examples of matrices include, but are not limited to, a polymer (e.g., polystyrene, epoxy, polyimides, PMMA), a glass (e.g., silica glass), a gel (e.g., a silica gel), a resin, or any other materials which are at least partially, and preferably fully transparent to the light emitted and absorbed (the light which excites the nanocrystals) by the nanocrystals and in which the nanocrystals are incorporated. Resins can be non-curable resins, heat-curable resins, or photo-curable resins. Specific examples of resins can be in the form of an oligomer or a polymer, a melamine resin, a phenol resin, an alkyl resin, an epoxy resin, a polyurethane resin, a polyamide resin, polymethylmethacrylate, polyacrylate, polycarbonate, polyvinyl alcohol, hydroxyethylcellulose, carboxymethylcellulose, copolymers containing monomers forming these resins, or combinations thereof. Matrix resins are used individually or in combination. In some embodiments, a composition including a matrix can further include scatterers such as metal particles, metal oxide particles, glass, or polymer beads. Other appropriate scatterers can also be used without limitation.

Having prepared the composition containing the InP nanocrystals synthesized according to the methods disclosed in the present invention, it is then useful to create a coating. As is well known in the art, three low cost techniques for forming the coatings are drop casting, spin coating and ink jetting. Other methods can also be used without limitation.

In some embodiments, the composition further includes a liquid medium. In some embodiments, the liquid medium is polar, in others, non-polar.

### Example 1

All three synthetic examples below were performed using a standard Schlenk line.

### InP Nanocrystals

0.12 g (0.52 mmol) myristic acid, 0.022 g (0.05 mmol) zinc undecylenate and 7 ml 1-octadecene (ODE) were loaded into a three-neck flask. The mixture was degassed at 100° C. for 2 hours and pump-purged under N₂ three times. After switching to N₂ overpressure, the flask contents were taken up to 310° C., and the precursor solution of 0.024 g (0.15 mmol) trimethylindium (In(Me)₃), 0.019 g (0.075 mmol) tris(trimethylsilyl)phosphine (P(TMS)₃), 0.1 mmol octylamine and 2 ml ODE, prepared beforehand in a dry box, was added into the hot mixture by immediate injection from a syringe. After the injection, the reaction mixture was stirred at 270° C. for 6 minutes. The reaction was then stopped by removing the heating source.

### Example 2

### InP/ZnSe Nanocrystals

0.12 g (0.52 mmol) myristic acid, 0.044 g (0.1 mmol) zinc undecylenate and 7 ml 1-octadecene (ODE) were loaded into a three-neck flask. The mixture was degassed at 100° C. for 2 hours and pump-purged under N₂ three times. After switching to N₂ overpressure, the flask contents were taken up to 310° C., and the precursor solution of 0.024 g (0.15 mmol) trimethylindium (In(Me)₃), 0.019 g (0.075 mmol) tris(trimethylsilyl)phosphine (P(TMS)₃), 0.1 mmol octylamine and 2 ml ODE, prepared beforehand in a dry box, was added to the hot mixture by immediate injection from a syringe. After the injection, the reaction mixture was stirred at 270° C. for 6 minutes. The reaction was then stopped by removing the heating source. After the flask was cooled down to room temperature, 0.069 g (0.376 mmol) zinc acetate was added and the mixture was annealed under N₂ overpressure at 240° C. for 2.5 hours. After the anneal, the temperature was lowered to 230° C. A solution of 30 mg (0.38 mmol) selenium and 200 μl tri-n-butylphosphine dissolved in 5 ml ODE was slowly added dropwise under vigorous stirring. After the addition, the solution was left at 230° C. to stir for another hour to form InP/ZnSe nanocrystals.

Optical properties of the as-prepared InP/ZnSe nanocrystals were measured in anhydrous toluene. The sample had an emission peak maximum at 550 nm with a FWHM of 60 nm. The emission quantum yield was 63%.

### Example 3

### InP/ZnS Nanocrystals

0.12 g (0.52 mmol) myristic acid, 0.033 g (0.15 mmol) zinc undecylenate and 7 ml 1-octadecene (ODE) were loaded into a three-neck flask. The mixture was degassed 100° C. for 2 hours and pump-purged under N₂ three times. After switching to N₂ overpressure, the flask contents were taken up to 310° C., and the precursor solution of 0.024 g (0.15 mmol) trimethylindium (In(Me)₃), 0.019 g (0.075 mmol) tris(trimethylsilyl)phosphine (P(TMS)₃), 0.1 mmol octylamine and 2 ml ODE, prepared beforehand in a dry box, was added to the hot mixture by immediate injection from a syringe. After the injection, the reaction mixture was stirred at 270° C. for 6 minutes. The reaction was then stopped by removing the heating source.

After the flask was cooled down to room temperature, 0.069 g (0.376 mmol) zinc acetate was added and the mixture was annealed at 240° C. for 2.5 hours. After the anneal, the temperature was lowered to 230° C. A solution of 12 mg (0.38 mmol) sulfur dissolved in 5 ml ODE was slowly added dropwise under vigorous stirring. After the addition, the solution was left at 230° C. to stir for another hour to form InP/ZnS nanocrystals.

Optical properties of the as-prepared InP/ZnS nanocrystals were measured in anhydrous toluene. The sample had an emission peak maximum at 546 nm with a FWHM of 53 nm. The emission quantum yield was 45%.

The invention has been described in detail with particular reference to certain preferred embodiments thereof, but it will be understood that variations and modifications can be effected within the spirit and scope of the invention.

### PARTS LIST

200 semiconductor core
205 semiconductor nanocrystal
210 organic ligand

1. A method of making a colloidal solution of indium phosphide semiconductor nanocrystals, comprising:
(a) forming a first solution by combining solvents and ligands; and
(b) heating the first solution to a temperature equal to or higher than 290° C. and, while heating, adding to the first solution, a second solution containing trialkylindium, a phosphorus precursor, solvents and ligands so that a reaction takes place that forms a colloidal solution of indium phosphide semiconductor nanocrystals.

2. The method of claim 1, wherein the first solution includes a carboxylic acid as the ligand.

3. The method of claim 2, wherein the carboxylic acid is myristic acid, stearic acid, palmitic acid, lauric acid, decanoic acid, or oleic acid, or combinations thereof.

4. The method of claim 1, wherein the first solution includes a column II compound as the ligand.

5. The method of claim 4, wherein the column II compound is a zinc compound.

6. The method of claim 5, wherein the zinc compound is zinc carboxylate.

7. The method of claim 6, wherein the zinc compound is zinc acetate, zinc undecylenate, zinc stearate, zinc palamitate, zinc myristate, zinc laurate, or zinc oleate, or combinations thereof.

8. The method of claim 1, wherein the first solution includes a carboxylic acid and a column II compound as the ligands.

9. The method of claim 8, wherein the first solution includes a carboxylic acid and a zinc compound as the ligands.

10. The method of claim 1, wherein the trialkyllindium is selected from trimethylindium, triethylindium, di-isopropylmethylindium, or ethyldimethylindium, or combinations thereof.

11. The method of claim 1, wherein the phosphorus precursor is selected from hydrogen phosphine, tris(trimethylsilyl)phosphine, tris(dimethylamino)phosphine, tricyclopentylphosphine, tricyclohexylphosphine, triallylphosphine, di-2-norbornylphosphine, dicyclopentylphosphine, dicyclohexylphosphine, dibutylphosphine, cyclohexylphosphine, di-t-butylchlorophosphine, bis(dicyclohexylphosphino)methane, bis(dicyclohexylphosphino)ethane, or benzyl-1-adamantylphoshine, or combinations thereof.

12. The method of claim 1, wherein the second solution includes an amine as the ligand.

13. The method of claim 12, wherein the amine is hexylamine, octylamine, decylamine, undecylamine, dodecylamine, hexadecylamine, octadecylamine, oleylamine, dioctylamine, or cyclododecylamine, or combinations thereof.

14. The method of claim 1, wherein the solvent in the first or second solutions is selected from 1-octadecene, 1-eicosene, squalene, squalane, esters, or ethers, or the combinations thereof.

15. The method of claim 1, wherein the first solution is heated to a temperature of 300° C. prior to the second solution being added to it.

16. The method of claim 1 wherein the indium phosphide semiconductor nanocrystal has one or a plurality of semiconducting shells deposited on at least a portion of the indium phosphide core surface.

17. The method of claim 16, wherein the shell is a binary, ternary, or quaternary II-VI or III-V semiconductor compound.

18. The method of claim 17, wherein the shell is ZnS, ZnSe, InGaP, CdZnSe, or ZnSeS.

19. A method of making a colloidal solution of core shell indium phosphide semiconductor nanocrystals, comprising:
(a) forming a first solution by combining solvents and ligands;
(b) heating the first solution to a temperature equal to or higher than 290° C. and, while heating, adding to the first solution, a second solution containing trialkylindium, a phosphorous precursor, solvents and ligands so that a reaction takes place that forms a colloidal solution of indium phosphide core semiconductor nanocrystals; and
(c) adding one or more than one column II or III precursors to the colloidal solution of indium phosphide core semiconductor nanocrystals; annealing the combined solution; then to the annealed solution, adding one or more than one column VI or V precursors to form a colloidal solution of core shell indium phosphide nanocrystals.

20. The method of claim 19, wherein the annealing step in (c) is done at a temperature between 150° C. and 280° C.

21. The method of claim 20, wherein the annealing step is done at a temperature between 180° C. and 250° C.

22. The method of claim 19, wherein the column II and III precursors are selected from ZnO, ZnCO₃, Zn(Ac)₂, Zn(Et)₂, zinc stearate, Cd(Me)₂, CdO, CdCO₃, Cd(Ac)₂, CdCl₂, Cd(NO₃)₂, CdSO₄, Mg(acac)₂, MgCl₂, Mg stearate, bis(cyclopentadienyl) magnesium, Al(Me)₃, Al(Ac)₃, Al(acac)₃, AlCl₃, Ga(Me)₃, Ga(Et)₃, Ga(acac)₃, GaCl₃, In(Ac)₃, InCl₃, In(Me)₃, In(Me)₃, or InC₅H₅, or combinations thereof.

23. The method of claim 19, wherein the column VI and V precursors are selected from sulfur, tri-n-butylphosphine sulfide, tri-n-octylphosphine sulfide, bis(trimethylsilyl)sulfide, hydrogen sulfide, tri-n-butylphosphine selenide, tri-n-octylphosphine selenide, selenourea, tri-n-butylphosphine telluride, tri-n-octylphosphine telluride, tris(trimethylsilyl)phosphine, tris(dimethylamino)phosphine, dicyclopentylphosphine, dicyclohexylphosphine, cyclohexylphosphine, tris(trimethylsilyl)arsine, tris(dimethylamino)arsine, tricyclopentylarsine, tricyclohexylarsine, triallylarsine, tert-butylamine, or combinations thereof.

24. The method of claim 19 wherein the nanocrystal has a photoluminescence quantum yield no less than 30%.

25. The method of claim 19 wherein the nanocrystal has a photoluminescence quantum yield no less than 45%.

26. The method of claim 19 wherein the nanocrystal has a photoluminescence quantum yield no less than 60%.

27. A composition comprising the InP semiconductor nanocrystals of claim 1 dispersed in a matrix.

28. A composition of claim 27, wherein the InP semiconductor nanocrystals are dispersed in a matrix randomly or homogeneously.

29. A composition of claim 28, wherein the matrix is a polymer, a glass, a gel, a resin, or a liquid, or combinations thereof.

30. A coating of the composition of claim 27.
